(19) United States
(12) Patent Application Publication
(10) Pub. No.: US 2016/0205433 A1
(43) Pub. Date: Jul. 14, 2016

(54) METHOD AND SYSTEM FOR MANAGING TUNERS OF CLIENT DEVICES

(71) Applicant: Wipro Limited, Bangalore (IN)

(72) Inventors: Gowrishankar Subramaniam Natarajan, Chennai (IN); Harish Nair Rajagopal, Trivandrum (IN)

(21) Appl. No.: 14/635,611

(22) Filed: Mar. 2, 2015

(30) Foreign Application Priority Data
Jan. 8, 2015 (IN) 133/CHE/2015

(51) Int. Cl. H04N 21/4335; H04N 21/458; H04N 21/433; H04N 21/4147; H04N 21/239

(52) U.S. Cl. CPC H04N 21/4335; H04N 21/4147; H04N 21/2393; H04N 21/4334; H04N 21/4583

(57) ABSTRACT

The present disclosure relates to a methods, non-transitory computer readable media, and tuner manager computing devices receive a request to allocate a tuner for recording or playback of a broadcast program from one or more client devices. The system determines states and available recording space of one or more tuners associated with the client devices. The system also determines business rules associated with the client devices based on state, available recording space and type of request received. Based on the business rules, the system identifies a tuner to service the request and allocate the tuner to service the request of the client devices. Thus the system provides multiple device tuner management by identifying and assigning a tuner appropriate to service the request from client device and also identifies the correct tuner with appropriate storage space available to service the request.

This application claims the benefit of Indian Patent Application No. 133/CHE/2015 filed Jan. 8, 2015, which is hereby incorporated by reference in its entirety.

### FIELD

The present subject matter is related, in general to system and method for managing tuner resources, and more particularly, but not exclusively to allocating tuner resources to client devices.

### BACKGROUND

Today, digital satellite systems and cable television systems offer hundreds of television channels from which a user may select. In addition to delivering audio video content, these systems also deliver other types of content or data that can be stored and retrieved later. Various types of viewing content include live broadcast TV, live TV over IP, Pay per view content and recording content include recording content on local device, or on remote device or on remote cloud based or network storage device are available. In order to receive the various types of content, however, the user may be required to tune to an appropriate channel. Tuners therefore are important resources for retrieving content from various sources. Tuners are configured based on user accounts, privileges provided, hardware & software limitations, addition or removal of tuners, and type of content.

Conventional tuners create potential conflicts in scenarios when multiple users are using these devices at home as the client devices involve complex process to enable interaction between different devices in order to identify the tuners for viewing or recording content. Further, conventional tuners also create conflicts in real time when the tuner scheduled for recording is used for higher priority tasks like watching live video on demand or pay per view content. Furthermore, conventional tuners also lack the ability to effectively use available storage space across devices for storing or recording content. In addition, the ability of a user to efficiently use the tuners is limited by irrelevant allocation of tuners to requests from client devices, inappropriate allocation and management of storage space and so on.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of managing tuners for one or more client devices. The method comprising receiving a request to allocate one or more tuners for at least one of recording or playback of a broadcast program by one or more recording devices and determining one or more tuners states and available recording space of corresponding tuners associated with the one or more client devices in real time. The method further determines one or more business rules associated with the one or more client devices based on at least one of the one or more tuners state, available recording space of one or more tuners and type of the request. Based on the one or more business rules, the method identifies a tuner to service the request of the one or more client devices and allocates the identified tuner to service the request of the one or more client devices.

Further, the present disclosure relates to a system for managing tuners for one or more client devices. The system comprises one or more client devices coupled with the one or more recording devices. The system further comprises a tuner manager coupled with the one or more client devices and the one or more recording devices. The tuner manager comprises a processor and a memory communicatively coupled to the processor, wherein the memory stores processor-executable instructions, which, on execution, cause the processor to receive, from the one or more client devices, a request to allocate one or more tuners for at least one of recording or playback of a broadcast program by one or more recording devices. The processor is furthermore configured to determine one or more tuners states and available recording space of corresponding tuners associated with the one or more client devices in real time. Further, the processor is configured to determine one or more business rules associated with the one or more client devices based on at least one of the one or more tuners state, available recording space of one or more tuners and type of the request. Based on the one or more business rules, the processor identifies a tuner to service the request of the one or more client devices and allocate the tuner to service the request of the one or more client devices.

Furthermore, the present disclosure relates to a non-transitory computer readable medium including instructions stored thereon that when processed by at least one processor cause a system to perform the act of receiving a request to allocate one or more tuners for at least one of recording or playback of a broadcast program by one or more recording devices. Further, the instructions cause the processor to determine one or more tuners states and available recording space of corresponding tuners associated with the one or more client devices in real time and determine one or more business rules associated with the one or more client devices based on at least one of the one or more tuners state, available recording space of one or more tuners and type of the request. Based on the one or more business rules, the processor identifies a tuner to service the request of the one or more client devices and allocate the tuner to service the request of the one or more client devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for managing tuners in accordance with some embodiments of the present disclosure;

FIG. 2a illustrates a block diagram of recording device in accordance with some embodiments of the present disclosure;

FIG. 2b illustrates a block diagram of client device in accordance with some embodiments of the present disclosure;

FIG. 3 illustrates a block diagram of tuner manager in accordance with some embodiments of the present disclosure;

FIG. 4 illustrates a flowchart of a method of managing tuners in accordance with some embodiments of the present disclosure;

FIG. 5 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for managing tuners of client devices. In one embodiment, a request to allocate a tuner for recording or playback of a broadcast program is received by one or more recording devices from one or more client devices. The system determines states and available recording space of one or more tuners associated with the client devices. The system also determines business rules associated with the client devices based on state, available recording space and type of request received. Based on the business rules, the system identifies a tuner to service the request and allocate the tuner to service the request of the client devices. Thus the system provides multiple device tuner management by identifying and assigning a tuner appropriate to service the request from client device and also identifies the correct tuner with appropriate storage space available to service the request.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

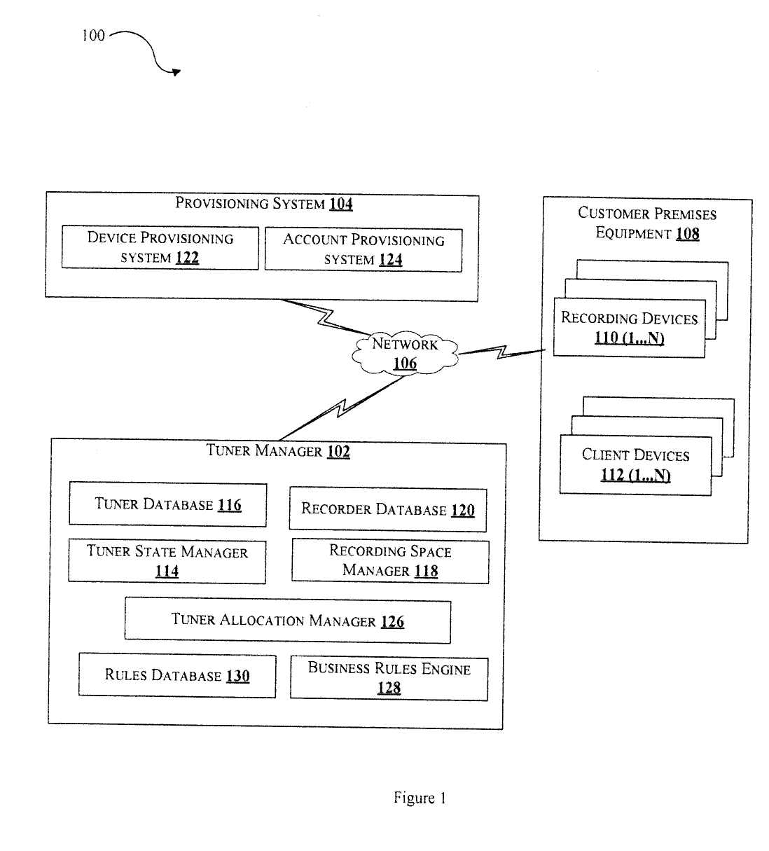

FIG. 1 illustrates architecture of system 100 for managing tuners of client devices in accordance with some embodiments of the present disclosure.

As shown in FIG. 1, the system 100 comprises a tuner manger computing device 102 for managing one or more tuners of one or more client devices communicatively coupled with the tuner manager 102. In one embodiment, the tuner manager 102 is coupled with a provisioning system 104 via a communication network 106. The provisioning system 104 provides information about the one or more client devices and one or more user accounts associated with the client devices. The tuner manager 102 is also coupled with customer premises equipment (CPE) 108 via the communication network 106. The CPE 108 comprises one or more recording devices 110-1, 110-2, . . . 110-N (hereinafter collectively referred to as recording device 110) and the one or more client devices 112-1, 112-2, . . . 12-N (hereinafter collectively referred to as client device 112).

The tuner manager 102 comprises one or more components configured to enable dynamic management of tuners. In one embodiment, the tuner manager 102 comprises at least a tuner state manager 114 and a tuner database 116 coupled with the tuner state manager 114. The tuner state manager 114 receives one or more requests for information on tuners including status and current state of the tuners and retrieves the requested status and current state information from the tuner database 116. The tuner manager 102 further comprises a recording space manager 118 and a recording database 120 coupled with the recording space manager 118 and the tuner database 116. The recording space manager 118 receives one or more notifications about available and used recording spaces from CPE 108 and updates the recording database 120 based on the received notifications. Both the tuner state manager 114 and the recording space manager 118 are coupled to the provisioning system 104.

The provisioning system 104 is configured to initialize the tuner database 116 and the recording database 120 with information related to user accounts, client devices, tuners and recording spaces. In one embodiment, the provisioning system 104 comprises a device provisioning system 122 that provides information including, but not limited to, list of client devices 112, associated capabilities and usage statistics of the client devices 112. The provisioning system 104 further comprises an account provisioning system 124 that provides information including, but not limited to, list of user accounts and associated capabilities and privileges, list of devices associated with the user accounts and list of recording services configured for the user accounts and their usage limitations like number of tuners, space available or space used etc. Both the device provisioning system 122 and the account provisioning system 124 initializes each of the tuner database 118 and the recording database 120 before the allocation of tuners.

In addition to initialization of the tuner database 118 with tuner information, the tuner manager 102 also retrieves tuner information across each recording device 110 for each user account. In one embodiment, the tuner manager 102 comprises an account or device data cache (not shown) (hereinafter referred to as data cache) which stores tuner information across each recording device 110 for each user account and across all user accounts. The data cache interfaces expectations with a tuner-to-device/account mapping component (not shown) for retrieving tuner information across one or more client devices 112 and user accounts. In one embodiment, the data cache uses one of a HTTP GET interface or a bulky GET/GET RESPONSE interfaces to receive tuner information. Further, the data cache provides a SUBSCRIBE-NOTIFICATION interface to register for receiving new client device/accounts provision & de-provision notifications so that the local cache can be updated accordingly.

The tuner manager 102 also comprises a tuner allocation manager 126 that services the requests for allocation of tuners received from client device 112 based on one or more predetermined business rules and other factors including type of request, availability of recording space and tuners and so on. In one embodiment, the one or more predetermined business rules are configured by a business rules engine 128 coupled with the tuner allocation manager 126. The business rules engine 128 determines the one or more business rules based on inputs from user and update a rules database 130 coupled with the business rules engine 128 with the determined rules. The business rules engine 128 generates the one or more business rules that defines the priority of tuner allocation based on one or more factors including relative series recording priorities, series versus single recording priorities, most recently scheduled recording priority, type of device scheduling the recording, space availability on recording device requesting the schedule, real-time tuner state information across recording devices mapped to user account and relative service priority across Linear, VOD, PPV & Recording services. The tuner allocation manager 126 process the allocation requests received from the client device 112 based on the predetermined business rules and real time information on state and status of tuners associated with the user account received from the recording device 110 of the CPE 108.

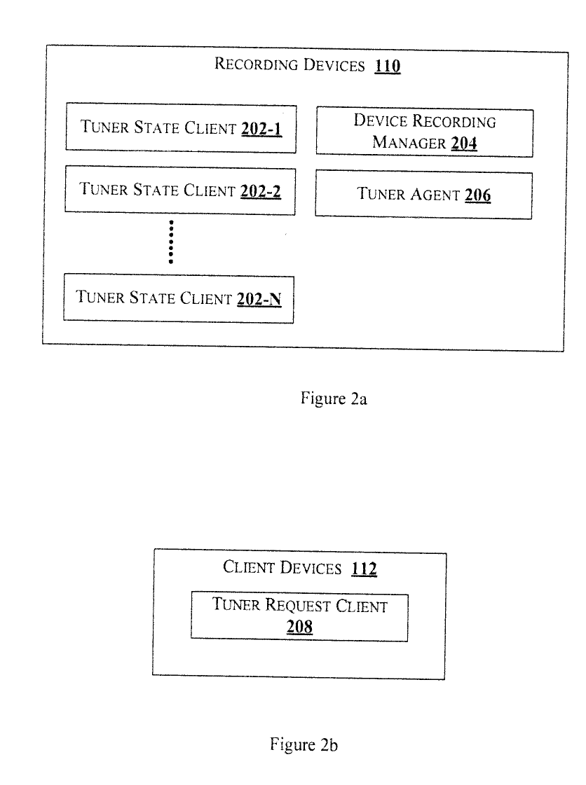

As illustrated in FIG. 2a, the recording device 110 comprises at least one or more tuner state clients 202-1, 202-2, . . . 202-N (hereinafter collectively referred to as tuner state client 202) corresponding to one or more tuners and coupled with the tuner state manager 114. The tuner state client 202 maintains current state and usage status of the tuners associated with the user account and dynamically updates the tuner state manager 114 with modified state and usage status of tuners in real time for enabling allocation of tuners.

The recording device 110 also comprises a device recording manager 204 coupled with the recording space manager 118. In one embodiment, the device recording manager 204 maintains information on current free and used recording spaces for recording operations and dynamically updates the recording space manager 118 with information on free and used recording spaces once recording is completed. In another embodiment, the device recording manager 204 updates the recording space manager 118 with information on recording space that is required to be reserved at the beginning of the recording operation. In yet another embodiment, the device recording manager 204 updates the recording space manager 118 with information on free, used and reserved recording space during the recording operation. In still another embodiment, the device recording manager 204 updates the recording space manager 118 with information on free and used recording space when existing recordings are deleted or modified.

The recording device 110 also comprises a tuner agent 206 coupled with the tuner allocation manager 126. In one embodiment, the tuner agent 206 collects information including recording space availability, type of request like recording or playback and so on from the client device 112 or from user accounts via a third party operator application services. The tuner agent 206 transmits the collected information to the tuner allocation manager 126 for using in business rules determination and identification of tuners. Upon allocation of tuners, the tuner agent 206 receives instruction from the tuner allocation manager 126 and updates the status of allocated tuners with the tuner state client 202.

As illustrated in FIG. 2b, the client device 112 comprises a tuner request client 208 coupled with the tuner allocation manager 126. The tuner request client 208 handles request for allocation/de-allocation of tuners received from third party application when playback or recording of IP/broadcast, VoD, or PPV content is required. On receiving the request, the tuner request client 208 sends the request to the tuner allocation manager 126 along with additional information including recording space availability, and type of request for evaluation of one or more business rules.

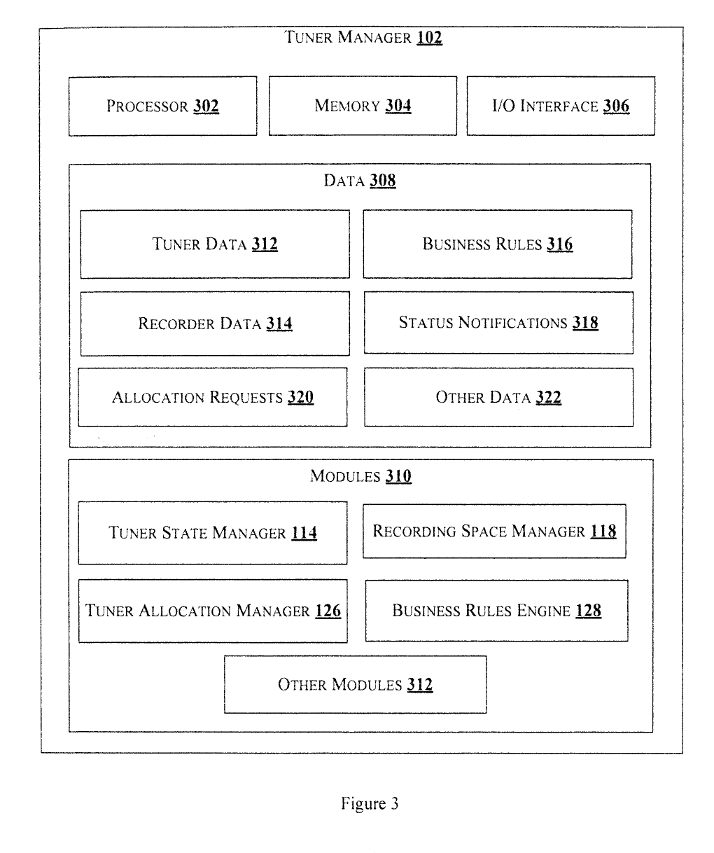

The tuner manager 102 is described in greater details below with reference to FIG. 3. In one implementation, the exemplary tuner manager 102 includes a central processing unit (“CPU” or “processor”) 302, the memory 304 and an I/O interface 306. The I/O interface 306 is coupled with the processor 302 and an I/O device. The I/O device is configured to receive inputs via the I/O interface 306 and transmit outputs for displaying in the I/O device via the I/O interface 306.

The tuner manager 102 further comprises data 308 and modules 310.

In one implementation, the data 308 and the modules 310 may be stored within the memory 304. In one example, the data 308 may include tuner data 312, recorder data 314, tuner business rules 316, status notifications 318, allocation requests 320 and other data 322. In one embodiment, the data 308 may be stored in the memory 304 in the form of various data structures. Additionally, the aforementioned data can be organized using data models, such as relational or hierarchical data models. The other data 322 may be used to store data, including temporary data and temporary files, generated by the modules 310 for performing the various functions of the tuner manager 102.

The modules 310 may include, for example, the tuner state manager 114, the recording space manager 118, the tuner allocation manager 126 and the business rules engine 128. The modules 310 may also comprise other modules 312 to perform various miscellaneous functionalities of the tuner manager 102. It will be appreciated that such aforementioned modules may be represented as a single module or a combination of different modules.

In operation, the tuner manager 102 initializes the tuner database 118 and recording database 120 with the tuner data 312 and the recorder data 314 received from the provisioning system 104 and allocates one or more tuners in response to requests received from the client device 112 based on the tuner data 312 and the recorder data 314. In one example, the tuner state manager 114 of the tuner manager 102 initializes the tuner database 118 with the tuner data 312 such as list of client devices 112 and associated capabilities and usage statistics of the client devices 112 received from the device provisioning system 122. The tuner state manager 114 also initializes the tuner database 118 with the tuner data 312 related to user accounts of client devices 112 received from the account provisioning system 124. For example, the tuner data 312 received from the account provisioning system 124 include, but not limited to, list of user accounts and associated capabilities and privileges, list of devices associated with the user accounts and list of recording services configured for the user accounts and their usage limitations like number of tuners, space available or space used etc.

The recording space manager 118 of the tuner manager 102 initializes the recording database 120 with the recorder data 314 received from the provisioning system 108 and allocates memory space for recording operations upon initialization. In one example, the recording space manager 118 receives and initializes the recording database 120 with information including, but not limited to, total recording space available for client device 112, size of each recordings already available in the client device 112 and information on reserved recording space used for temporary purposes.

Once initialized, the tuner state manager 114 may receive one or more notifications 318 from the tuner state client 202 associated with the one or more user accounts and maintains current status and states of the one or more tuners based on the received notifications 318. In one embodiment, the tuner state manager 114 receives one or more notifications on tuner state whenever there is a change in the tuner state such as change in the channel, or change in the service like Live TV, VoD, Recording, DVR view etc., and updates the tuner database 116 accordingly. In another example, the tuner state manager 114 updates the status and states of the tuners using an in-built state machine associated with each user account for each recording device 110. The recording space manager 118 also receives one or more notifications regarding information on recording space (available, used or reserved) from the device recording manager 204 and updates the recorder database 120 accordingly.

A request 320 for allocation of tuner from a third party application for playback or recording of content is received by the tuner request client 208 of the client device 112. The tuner request client 208 requests the tuner agent 206 of the recording device 110 to collect information on space availability, type of request and so on from the client device 112 or from the user account associated with the client device 112 via the third party application. Upon receiving the additional information from the tuner agent 206, the tuner request client 208 transmits the allocation request 320 and the additional information to the tuner allocation manager 126.

The tuner allocation manager 126 receives the allocation request 320 along with additional information and services the allocation request based on predetermined business rules and the additional information thus received. In one embodiment, the tuner allocation manager 126 transmits a READ request for tuner status and current state of one or more tuners to the tuner state manager 114. The tuner state manager 114 receives the READ request and retrieves the tuner status and current state of the one or more tuners from the tuner database 116 and updates the tuner allocation manager 126 with the retrieved status and state tuner information. Upon receiving the current status and state of tuners, the tuner allocation manager 126 retrieves available recording space from the recorder database 120 for the client device 112 that made the allocation request 320.

Further, the tuner allocation manager 126 determines one or more business rules 316 based on the received tuner status and state information and additional information. In one embodiment, the tuner allocation manager 126 retrieves the one or more business rules 316 that are set or updated by the operator and configured by the end user in the rules database 130. The one or more business rules 316 defines the priority of tuner allocation based on one or more factors including relative series recording priorities, series versus single recording priorities, most recently scheduled recording priority, type of device scheduling the recording, space availability on recording device requesting the schedule, real-time tuner state information across recording devices mapped to user account and relative service priority across Linear, VOD, PPV & Recording services.

The tuner allocation manager 126 identifies an appropriate tuner based on arbitration of business rules 316, tuner availability and recording space availability. If it is determined that the arbitration is successful, then the tuner allocation manager 126 sends one or more instructions to the tuner agent 206 to reserve the identified tuner. The tuner allocation manager 126 also sends a response to the allocation request 320 to the tuner request client 208 with success or failure message based on success or failure of arbitration. Upon receiving the instructions to reserve the identified tuner, the tuner request client 208 updates the status of the identified tuner as “reserved” or “allocated” in the corresponding tuner state client 202. The tuner state client 202 also sends the change in the state of the reserved tuner to the tuner state manager 114. The tuner state manager 114 then updates the state of the reserved tuner in the tuner database 116.

The system 100 thus provides multi-device tuner pooling with dynamic tuner management, arbitration and allocation in response to recording requests received from the client device 112. The system 100 also identifies the status and state of the tuners in real time across all the client devices 112 associated with user account. Further, the system 100 identifies the appropriate tuner and required recording space and directs the request for playback or recording of content to the identified tuner in real time.

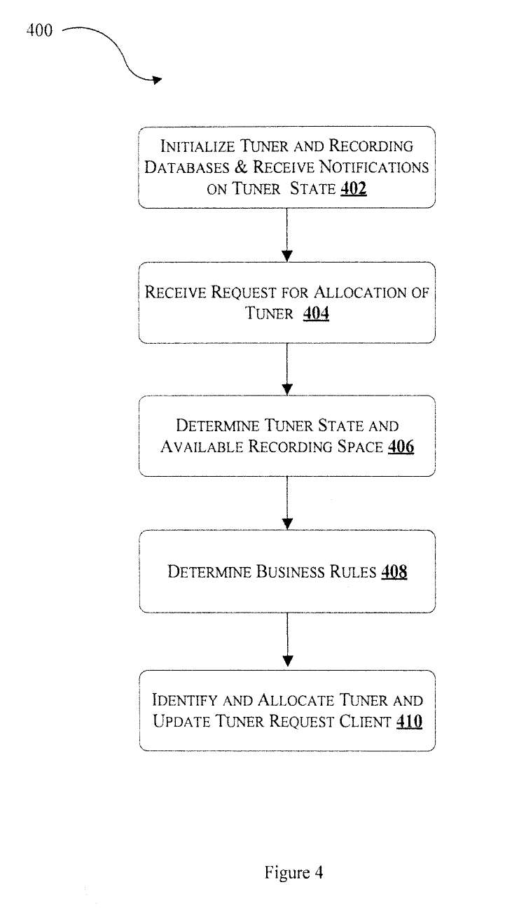

FIG. 4 illustrates a flowchart of method of managing tuners in accordance with an embodiment of the present disclosure.

As illustrated in FIG. 4, the method 400 comprises one or more blocks implemented by the processor 302 of the tuner manager 102 for managing tuners. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method 400. Additionally, individual blocks may be deleted from the method 400 without departing from the spirit and scope of the subject matter described herein. Furthermore, the method 400 can be implemented in any suitable hardware, software, firmware, or combination thereof.

At block 402, initialize tuner and recording databases & receive notifications on tuner state. In one embodiment, the tuner manager 102 initializes the tuner database 118 and recording database 120 with the tuner data 312 and the recorder data 314 received from the provisioning system 104 and allocates one or more tuners in response to requests received from the client device 112 based on the tuner data 312 and the recorder data 314. In one example, the tuner state manager 114 of the tuner manager 102 initializes the tuner database 118 with the tuner data 312 such as list of client devices 112 and associated capabilities and usage statistics of the client devices 112 received from the device provisioning system 122. The tuner state manager 114 also initializes the tuner database 118 with the tuner data 312 related to user accounts of client devices 112 received from the account provisioning system 124. The recording space manager 118 of the tuner manager 102 initializes the recording database 120 with the recorder data 314 received from the provisioning system 108 and allocates memory space for recording operations upon initialization.

Once initialized, the tuner state manager 114 may receive one or more notifications 318 from the tuner state client 202 associated with the one or more user accounts and maintains current status and states of the one or more tuners based on the received notifications 318. In one embodiment, the tuner state manager 114 receives one or more notifications on tuner state whenever there is a change in the tuner state such as change in the channel, or change in the service like Live TV, VoD, Recording, DVR view etc., and updates the tuner database 116 accordingly. The recording space manager 118 also receives one or more notifications regarding information on recording space (available, used or reserved) from the device recording manager 204 and updates the recorder database 120 accordingly.

At block 404, receive request for allocation of tuner. In one embodiment, a request 320 for allocation of tuner from a third party application for playback or recording of content is received by the tuner request client 208 of the client device 112. The tuner request client 208 requests the tuner agent 206 of the recording device 110 to collect information on space availability, type of request and so on from the client device 112 or from the user account associated with the client device 112 via the third party application. Upon receiving the additional information from the tuner agent 206, the tuner request client 208 transmits the allocation request 320 and the additional information to the tuner allocation manager 126.

At block 406, determine tuner state and available recording space. In one embodiment, the tuner allocation manager 126 receives the allocation request 320 along with additional information and determines current tuner state and available recording space for servicing the allocation request 320. In one embodiment, the tuner allocation manager 126 transmits a READ request for tuner status and current state of one or more tuners to the tuner state manager 114. The tuner state manager 114 receives the READ request and retrieves the tuner status and current state of the one or more tuners from the tuner database 116 and updates the tuner allocation manager 126 with the retrieved status and state tuner information. Upon receiving the current status and state of tuners, the tuner allocation manager 126 retrieves available recording space from the recorder database 120 for the client device 112 that made the allocation request 320.

At block 408, determine business rules. In one implementation, the tuner allocation manager 126 determines one or more business rules 316 based on the received tuner status and state information and additional information. In one embodiment, the tuner allocation manager 126 retrieves the one or more business rules 316 that are set or updated by the operator and configured by the end user in the rules database 130.

At block 410, identify, allocate tuner and update tuner request client. In one embodiment, the tuner allocation manager 126 identifies an appropriate tuner based on arbitration of business rules 316, tuner availability and recording space availability. If it is determined that the arbitration is successful, then the tuner allocation manager 126 sends one or more instructions to the tuner agent 206 to reserve the identified tuner. The tuner allocation manager 126 also sends a response to the allocation request 320 to the tuner request client 208 with success or failure message based on success or failure of arbitration. Upon receiving the instructions to reserve the identified tuner, the tuner request client 208 updates the status of the identified tuner as “reserved” or “allocated” in the corresponding tuner state client 202. The tuner state client 202 also sends the change in the state of the reserved tuner to the tuner state manager 114. The tuner state manager 114 then updates the state of the reserved tuner in the tuner database 116.

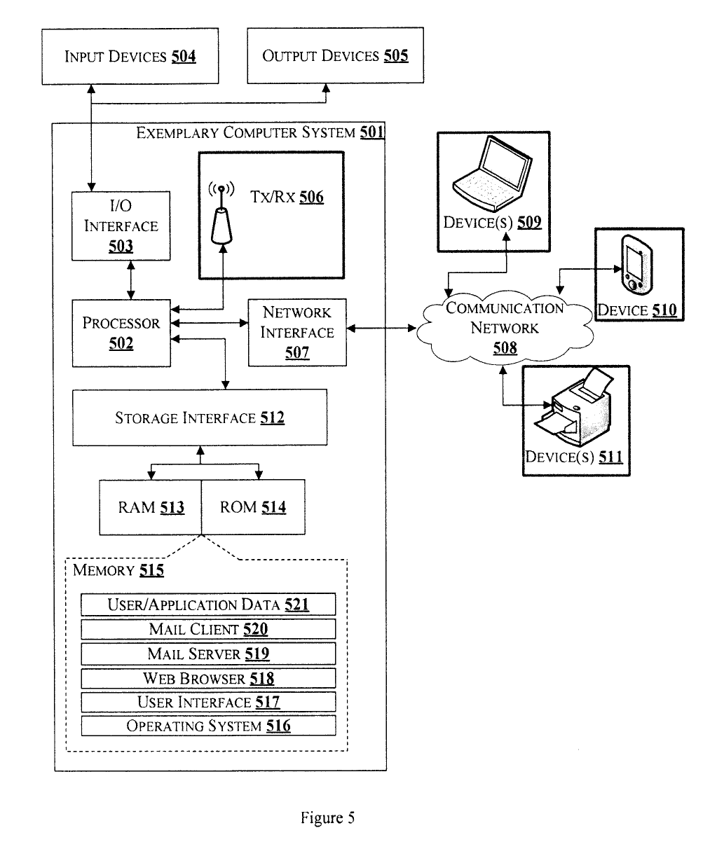

FIG. 5 is a block diagram of an exemplary computer system for implementing embodiments consistent with the present disclosure.

Variations of computer system 501 may be used for implementing all the computing systems that may be utilized to implement the features of the present disclosure. Computer system 501 may comprise a central processing unit (“CPU” or “processor”) 502. Processor 502 may comprise at least one data processor for executing program components for executing user- or system-generated requests. The processor may include specialized processing units such as integrated system (bus) controllers, memory management control units, floating point units, graphics processing units, digital signal processing units, etc. The processor 502 may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface 507 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 5Error! Reference source not found.14, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 515 may store a collection of program or database components, including, without limitation, an operating system SError! Reference source not found.16, user interface application 5Error! Reference source not found.17, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 310, amongst other things, include routines, programs, objects, components, and data structures, which perform particular tasks or implement particular abstract data types. The modules 310 may also be implemented as, signal processor(s), state machine(s), logic circuitries, and/or any other device or component that manipulate signals based on operational instructions. Further, the modules 310 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing tuners for client devices, the method comprising:
receiving, by a tuner manager computing device and from a client device, a tuner allocation request for recording or playback of a broadcast program by a recording device;
determining, by the tuner manager computing device, a state and an available recording space of each of a plurality of tuners associated with the client device in real time;
determining, by the tuner manager computing device, one or more business rules associated with the client device based on the state or the available recording space of one or more of the tuners and a type of the request;
identifying, by the tuner manager computing device, one of the tuners to service the tuner allocation request of the client device based on an application of the one or more business rules; and
allocating, by the tuner manager computing device, the one of the tuners to service the tuner allocation request of the client device.

2. The method as claimed in claim 1, further comprising:
receiving, by the tuner manager computing device, a notification regarding the state of one or more of the tuners before receiving the tuner allocation request; and
updating, by the tuner manager computing device, the state of the one or more of the tuners based on the notification.

3. The method as claimed in claim 1, wherein the allocating further comprises sending one or more instructions to a tuner agent of the recording device to reserve the one of the tuners for recording or playback of the broadcast program and responding to the tuner allocation request of the client device with a success or a failure message, upon determining that the identification of the one of the tuners is successful.

4. The method as claimed in claim 1, further comprising:
dynamically updating, by the tuner manager computing device, a current state of one or more of the tuners associated with an account of the client device; and
dynamically updating, by the tuner manager computing device, a status of recording spaces associated with the client device.

5. A tuner manager computing device comprising a processor and a memory coupled to the processor which is configured to be capable of executing programmed instructions comprising and stored in the memory to:
receive, from a client device, a tuner allocation request for recording or playback of a broadcast program by a recording device;
determine a state and an available recording space of each of a plurality of tuners associated with the client device in real time;
determine one or more business rules associated with the client device based on the state or the available recording space of one or more of the tuners and a type of the request;
identify one of the tuners to service the tuner allocation request of the client device based on an application of the one or more business rules; and
allocate the one of the tuners to service the tuner allocation request of the client device.

6. The tuner manager computing device as claimed in claim 5, wherein the processor is further configured to be capable of executing at least one additional programmed instructions comprising and stored in the memory to:
receive a notification regarding the state of one or more of the tuners before receiving the tuner allocation request; and
update the state of the one or more of the tuners based on the notification.

7. The tuner manager computing device as claimed in claim 5, wherein the allocating further comprises sending one or more instructions to a tuner agent of the recording device to reserve the one of the tuners for recording or playback of the broadcast program and responding to the tuner allocation request of the client device with a success or a failure message, upon determining that the identification of the one of the tuners is successful.

8. The tuner manager computing device as claimed in claim 5, wherein the processor is further configured to be capable of executing at least one additional programmed instructions comprising and stored in the memory to:
dynamically update a current state of one or more of the tuners associated with an account of the client device; and
dynamically update a status of recording spaces associated with the client device.

9. A non-transitory computer readable medium having stored thereon instructions for managing tuners for client devices comprising executable code which when executed by at least one processor, causes the processor to perform steps comprising:
receiving, from a client device, a tuner allocation request for recording or playback of a broadcast program by a recording device;
determining a state and an available recording space of each of a plurality of tuners associated with the client device in real time;
determining one or more business rules associated with the client device based on the state or the available recording space of one or more of the tuners and a type of the request;
identifying one of the tuners to service the tuner allocation request of the client device based on an application of the one or more business rules; and
allocating the one of the tuners to service the tuner allocation request of the client device.

10. The non-transitory computer readable medium as claimed in claim 9, further having stored thereon instructions comprising executable code which when executed by the processor further causes the processor to perform at least one additional step comprising:
receiving a notification regarding the state of one or more of the tuners before receiving the tuner allocation request; and
updating the state of the one or more of the tuners based on the notification.

11. The non-transitory computer readable medium as claimed in claim 9, wherein the allocating further comprises sending one or more instructions to a tuner agent of the recording device to reserve the one of the tuners for recording or playback of the broadcast program and responding to the tuner allocation request of the client device with a success or a failure message, upon determining that the identification of the one of the tuners is successful.

12. The non-transitory computer readable medium as claimed in claim 9, further having stored thereon instructions comprising executable code which when executed by the processor further causes the processor to perform at least one additional step comprising:
dynamically updating a current state of one or more of the tuners associated with an account of the client device; and
dynamically updating a status of recording spaces associated with the client device.
